(19) United States
(12) Patent Application Publication
(10) Pub. No.: US 2026/0178388 A1
(43) Pub. Date: Jun. 25, 2026

(54) ROUTING DIVERSE INCOMING REQUESTS TO OPTIMAL COMPUTING OPTIONS WHILE SATISFYING REQUISITE PERFORMANCE METRICS

(71) Applicants: Oracle International Corporation, Redwood Shores, CA (US); Indian Institute of Technology Roorkee, Roorkee (IN)

(72) Inventors: Manish Kumar Agrawal, Bangalore (IN); Sandeep Kumar, Roorkee (IN); Yogesh Kumar, Saratoga, CA (US)

(21) Appl. No.: 18/986,852

(22) Filed: Dec. 19, 2024

(51) Int. Cl. G06F 9/50

(52) U.S. Cl. CPC G06F 9/5027; G06F 2209/501

(57) ABSTRACT

An aspect of the present disclosure facilitates routing diverse incoming requests to optimal computing options while satisfying requisite performance metrics. In one embodiment, in a computing environment having multiple compute types, a historical data containing characteristics in transport payloads of incoming requests, and characteristics in processing corresponding incoming requests by respective compute types is collected. A system trains, based on the historical data, a machine learning (ML) model to select compute types for incoming requests. Upon receiving a new incoming request sought to be processed, the system extracts from a transport payload of the new incoming request, the first set of characteristics to create a new request context. The system then applies the ML model to the new request context to identify a target compute type and forwards the new incoming request to the target compute type.

### BACKGROUND OF THE DISCLOSURE

### Technical Field

The present disclosure relates to computing environments and more specifically to routing diverse incoming requests to optimal computing options while satisfying requisite performance metrics.

### Related Art

Complex computing environments (e.g., cloud infrastructures) increasingly present multiple computing options for processing incoming requests. A computing (or compute) option may be viewed as a set of processing resources, with different computing options being characterized with correspondingly different levels of processing power.

For example, a high compute option may contain high end graphical processing units (GPUs), while a standard compute option may contain basic processing resources such as central processing units (CPUs) only. There can be multiple other compute options also, with each compute option potentially being capable of processing the incoming requests of interest.

Incoming requests may need to be processed while satisfying requisite performance metrics. As is well known, performance metrics can measure aspects such as response time, cost of processing, throughput, resource (memory, processing/electric power, etc.) utilization, etc.

Diverse incoming requests differ in the computational power required for processing them. For example, in a sales cloud environment, a simple request may be to retrieve the details of an account, a normal request may be to retrieve the sales information for last few months, while a complex request may be to perform a sales forecast for the next few months.

Accordingly, it may be desirable that such diverse incoming requests be routed to optimal computing options while satisfying requisite performance metrics.

### BRIEF DESCRIPTION OF THE DRAWINGS

Example embodiments of the present disclosure will be described with reference to the accompanying drawings briefly described below.

FIG. 1A is a block diagram illustrating an example environment in which several aspects of the present disclosure can be implemented.

FIG. 1B illustrates the manner in which a cloud (computing environment) is hosted in computing infrastructures in one embodiment.

FIG. 2 is a flow chart illustrating the manner in which routing diverse incoming requests to optimal computing options while satisfying requisite performance metrics is facilitated according to aspects of the present disclosure.

FIG. 3A depicts the format of a packet encoding an incoming request in one embodiment.

FIG. 3B depicts the request contexts created for different incoming requests in one embodiment.

FIG. 3C the compute type available in a computing environment (cloud 170) in one embodiment.

FIG. 4 is a block diagram depicting an implementation of a load balancer (150) in one embodiment.

FIGS. 5A-5C depicts the beta distributions maintained for different request contexts in one embodiment.

FIG. 6 is a flow chart illustrating the manner in which the cost optimization in the selection of compute types for incoming requests is performed according to aspects of the present disclosure.

FIG. 7 is a block diagram illustrating the details of digital processing system in which various aspects of the present disclosure are operative by execution of appropriate executable modules.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE EMBODIMENTS OF THE DISCLOSURE

### 1. Overview

An aspect of the present disclosure facilitates routing diverse incoming requests to optimal computing options while satisfying requisite performance metrics. In one embodiment, in a computing environment having multiple compute types, a historical data containing characteristics in transport payloads of incoming requests, and characteristics in processing corresponding incoming requests by respective compute types is collected. A system trains, based on the historical data, a machine learning (ML) model to select compute types for incoming requests. Upon receiving a new incoming request sought to be processed, the system extracts from a transport payload of the new incoming request, the first set of characteristics to create a new request context. The system then applies the ML model to the new request context to identify a target compute type and forwards the new incoming request to the target compute type.

According to another aspect of the present disclosure, the characteristics in transport payload of an incoming request includes a resource path identifying a specific resource sought to be accessed, a verb indicating an action the incoming request seeks to perform on the specific resource, one or more query parameters specifying additional information for performing the action, and a payload size indicating the size of the transport payload of the incoming request.

According to one more aspect of the present disclosure, the characteristics in processing includes data indicating a respective compute type identified for the incoming request, and whether the processing of the incoming request by the respective compute type was a success or failure in meeting requisite performance metrics. In one embodiment, the requisite performance metrics includes one or more of response time, cost of processing, throughput, and resource utilization in the respective compute type.

According to an aspect of the present disclosure, the ML model is a Reinforcement Learning (RL) model (which uses the Thompson Sampling technique in one embodiment) and maintains beta distributions corresponding to combinations of request contexts and compute types used for processing the request contexts. Accordingly, for applying the ML model, a system first identifies, based on the RL model, a set of beta distributions corresponding to the new request context. The system then samples each of the set of beta distributions to estimate a corresponding success probability for each compute type and sets the target compute type to a compute type with a maximum value for the corresponding success probability.

According to another aspect of the present disclosure, a beta distribution for the combination of the new request context and the target compute type is defined by an alpha parameter and a beta parameter, with the alpha parameter indicating a success count of using the target compute type for processing the new request context, and the beta parameter indicating a failure count of using the target compute type for processing the new request context. A system determines a current value for a performance metric in the processing of the new incoming request by the target compute type, the performance metric being associated with a requisite value. The system changes the alpha parameter using a reward function and the beta parameter using a penalty function, where the reward function increases the alpha parameter when the current value is lower than the requisite value and the penalty function increases the beta parameter when the current value is higher than the requisite value.

According to one more aspect of the present disclosure, each compute type is associated with a corresponding compute cost. For changing, the system finds a set of candidate compute types having an average value for the performance metric comparable to the current value, and then selects from the set of candidate compute types, a candidate compute type having a minimum compute cost. The system executes the reward function if the candidate compute type is same as the target compute type and the penalty function otherwise.

According to yet another aspect of the present disclosure, the multiple compute types include a standard compute, a mid compute, a moderate compute, and a high compute, while the RL model is generated using the Thompson Sampling technique.

Several aspects of the present disclosure are described below with reference to examples for illustration. However, one skilled in the relevant art will recognize that the disclosure can be practiced without one or more of the specific details or with other methods, components, materials and so forth. In other instances, well-known structures, materials, or operations are not shown in detail to avoid obscuring the features of the disclosure. Furthermore, the features/aspects described can be practiced in various combinations, though only some of the combinations are described herein for conciseness.

### 2. Example Environment

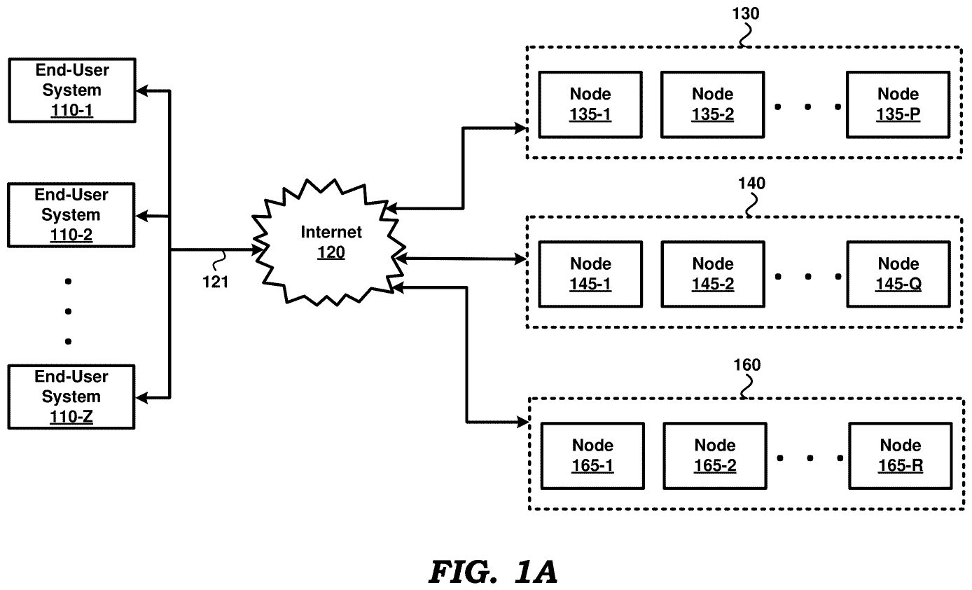

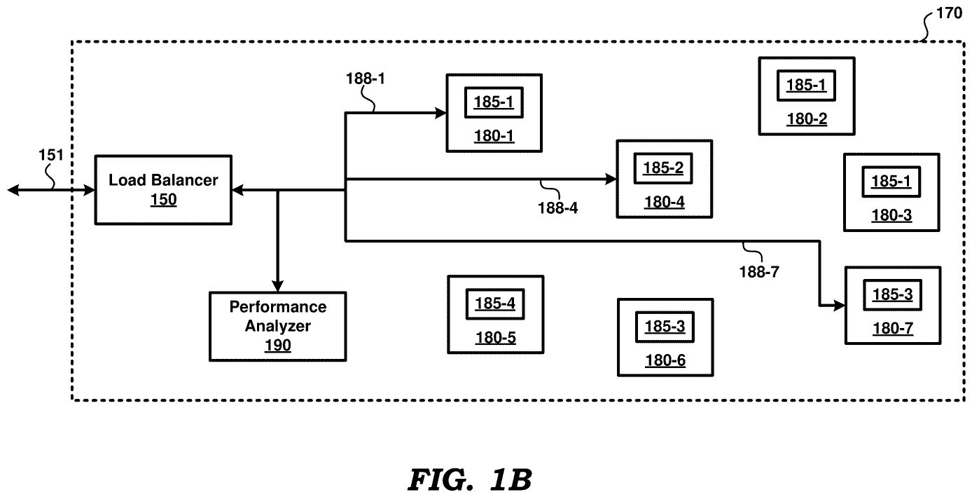

FIG. 1A is a block diagram illustrating an example environment in which several aspects of the present disclosure can be implemented. The block diagram is shown containing end-user systems 110-1 through 110-Z (Z representing any natural number), Internet 120, and computing infrastructures 130, 140 and 160. Computing infrastructure 130 in turn is shown containing nodes 135-1 through 135-P (P representing any natural number). Computing infrastructure 140 in turn is shown containing nodes 145-1 through 145-Q (Q representing any natural number). Computing infrastructure 160 in turn is shown containing nodes 165-1 through 165-R (R representing any natural number). The end-user systems and nodes are collectively referred to as 110, 135, 145 and 165 respectively.

Merely for illustration, only representative number/type of systems are shown in FIG. 1A. Many environments often contain many more systems, both in number and type, depending on the purpose for which the environment is designed. Each block of FIG. 1A is described below in further detail.

Each of computing infrastructures 130, 140 and 160 is a collection of physical processing nodes (135, 145 and 165), connectivity infrastructure, data storages, administration systems, etc., which are engineered to together host application/data services. For illustration, the aspects of the present disclosure are described below with respect to application services, though the same aspects can be applied to data services as well as will be apparent to one skilled in the relevant arts by reading the disclosure herein.

Computing infrastructure 130/140/160 may be a cloud infrastructure such as Amazon Web Services (AWS) available from Amazon.com, Inc., Azure available from Microsoft Corporation, Google Cloud Platform (GCP) available from Google LLC, Oracle Cloud Infrastructure (OCI) available from Oracle Corporation, etc. that provides a virtual computing infrastructure for various customers/tenants, with the scale of such computing infrastructure being specified often on demand. Alternatively, computing infrastructures 130/140/160 may also correspond to an enterprise system (or a part thereof) on the premises of the customers (and accordingly referred to as “On-prem” infrastructure). Computing infrastructures 130/140/160 may also be a “hybrid” infrastructure containing some nodes of a cloud infrastructure and other nodes of an on-prem enterprise system.

All the systems of each computing infrastructures 130/140/160 are assumed to be connected via a corresponding intranet (not shown). Internet 120 extends the connectivity of these (and other systems of the computing infrastructures) with external systems such as end-user systems 110. Each of the intranets (snot shown) and Internet 120 may be implemented using protocols such as Transmission Control Protocol (TCP) and/or Internet Protocol (IP), well known in the relevant arts.

In general, in TCP/IP environments, a TCP/IP packet is used as a basic unit of transport, with the source address being set to the TCP/IP address assigned to the source system from which the packet originates and the destination address set to the TCP/IP address of the target system to which the packet is to be eventually delivered. An IP packet is said to be directed to a target system when the destination IP address of the packet is set to the IP address of the target system, such that the packet is eventually delivered to the target system by Internet 120 and respective intranet. When the packet contains content such as port numbers, which specifies a target application, the packet may be said to be directed to such application as well.

Each of end-user system 110 represents a system such as a personal computer, workstation, mobile device, computing tablet, etc., used by users to generate (user) requests directed to application services executing in computing infrastructures 130/140/160. A user request refers to a specific technical request (for example, Universal Resource Locator (URL) call) sent to a server system from an external system (here, end-user system) over Internet 120, typically in response to a user interaction at end-user systems 110. The user requests may be generated by users using appropriate user interfaces (e.g., web pages provided by an application executing in a node, a native user interface provided by a portion of an application downloaded from a node, etc.).

In general, an end-user system 110 requests an application service for performing desired tasks and receives the corresponding responses (e.g., web pages) containing the results of performance of the requested tasks. The web pages/responses may then be presented to a user by a client application such as the browser. Each user request is sent in the form of an IP packet directed to the desired system or application service, with the IP packet including data identifying the desired tasks in the payload portion.

Some of nodes 135/145/165 may be implemented as corresponding data stores. Each data store represents a non-volatile (persistent) storage facilitating storage and retrieval of data by application services executing in the other systems/nodes of computing infrastructures 130/140/160. Each data store may be implemented as a corresponding database server using relational database technologies and accordingly provide storage and retrieval of data using structured queries such as SQL (Structured Query Language). Alternatively, each data store may be implemented as a corresponding file server providing storage and retrieval of data in the form of files organized as one or more directories, as is well known in the relevant arts.

Some of the nodes 135/145/165 may be implemented as corresponding server systems. Each server system represents a server, such as a web/application server, constituted of appropriate hardware, executing (user/enterprise) application services capable of performing one or more tasks. The tasks may be specified as part of user requests received from user systems 110 or node requests received from nodes of same/other cloud infrastructures. In the following disclosure, the term “incoming requests” is used as a common term for both user quests and node requests.

A server system, in general, receives an incoming request and performs the tasks requested in the incoming request. A server system may use data stored internally (for example, in a non-volatile storage/hard disk within the server system), external data (e.g., maintained in a data store) and/or data received from external sources (e.g., received from a user) in performing the requested tasks. The server system then sends the result of the performance of the tasks to the requesting system (end-user system 110 or node 135/145/165) as a corresponding response to the incoming request. The results may be accompanied by specific user interfaces (e.g., web pages) for displaying the results to a requesting user.

In one embodiment, cloud vendors operating the various computing infrastructures 130/140/160 provide customers/tenants with corresponding virtual computing environments (referred to as “clouds”) hosted on nodes 135/145/165. The clouds may be provided as a part of an Infrastructure-as-a-Service (IaaS), Platform-as-a-Service (PaaS), or Software-as-a-Service (SaaS), as is well known in the relevant arts. The manner in which such clouds may be hosted in computing infrastructures is described below with examples.

### 3. Hosting Clouds in Computing Instructure

FIG. 1B illustrates the manner in which a cloud (computing environment) is hosted in computing infrastructures in one embodiment. The block diagram is shown containing cloud (computing environment) 170, which in turn is shown containing load balancer 150, compute nodes 180-1 to 180-7, application services 185-1 to 185-4, and performance analyzer 190. The compute nodes and application services are collectively referred to as 180 and 185, respectively. Each block of the Figure is described in detail below.

Compute nodes 180 represent real or virtual infrastructure used for hosting application services in cloud 170. Each compute node 180 may correspond to one of nodes 135/145/165 shown in FIG. 1A. In one embodiment, virtual machines (VMs) form the basis for the deployment of various application services in the nodes of computing infrastructures 130/140/160. As is well known, a virtual machine may be viewed as a container in which other execution entities are executed. A node/server system can typically host multiple virtual machines, and the virtual machines provide a view of a complete machine (computer system) to the user applications executing in the virtual machine. In such an embodiment, compute nodes 180 correspond to VMs deployed in nodes 135/145/165.

It may be appreciated that compute nodes 180 represent corresponding compute options that perform the processing of incoming requests. Typically, as part of defining computing infrastructure in the cloud, providers often categorize compute nodes 180 into different “compute types” (also referred to as “compute shapes”) based on performance, workload requirements, hardware capabilities, etc.

Application services 185 represents software applications or components of such applications that are capable of performing one or more tasks. It may be observed that multiple instances of the same application service (e.g., 185-1, 185-3) may be hosted on compute nodes 180. Such multiple instances may be necessitated for load balancing, throughput performance, etc. as is well known in the relevant arts.

Load balancer 150 is designed to receive (via path 151) and distribute incoming requests to various compute nodes 180. The incoming requests may be received from end-user systems 110, compute nodes in other clouds or other nodes 135/145/165. For each incoming request, load balancer 150 selects an appropriate compute node 180 and routes/forwards the incoming request the selected compute node 180. In the Figure, load balancer 150 is shown having routed/forwarded (via paths 188-1, 188-4, 188-7, etc.) three incoming requests to corresponding compute nodes 180. The paths between load balancer 150 and compute nodes 180, such as 188-1, 188-4, 188-7, etc., are collectively referred to as path 188 hereinafter.

The selection of the appropriate compute node 180 for each incoming request is commonly based on factors such as maximizing throughput, minimizing cost and response time, improving performance and resource utilization, energy savings, etc., as is well known in the relevant arts. Typically, load balancer 150 delivers Service Level Agreement (SLA) and user satisfaction, while also preventing the situation where some compute nodes are overburdened while other compute nodes are idle or underutilized.

Performance analyzer 190 analyses the performance related to the processing of the incoming requests by respective selected compute nodes 180. Performance analyzer 190 may determine the performance by monitoring both the requests forwarded (via path 188) by load balancer 150 and the corresponding responses sent back (via path 188) by compute nodes 180. The processing performance may be quantified using one or more performance metrics, which may include Quality of Service (QoS) parameters, such as response time/latency, price/cost of processing, throughput, resource utilization, etc., well known in the relevant arts. Performance analyzer 190 typically determines the actual values for these performance metrics and checks whether the actual values satisfy the requisite performance metric conditions (e.g. <threshold for latency, >=threshold for throughput, etc.) as agreed between the cloud vendor and the customer/tenant.

It may be appreciated that in some environments such as IaaS/PaaS/SaaS, cloud providers/vendors may wish to optimize the usage of the underlying infrastructure (compute nodes) while meeting the requirements of providing high performance (that is, satisfying the requisite performance metrics) and scalability to the customers/tenants hosting the clouds. Such optimization may be desirable to keep down the costs of procuring and running the infrastructure. These two requirements are contradictory because providing high performance and scalability normally involves expensive hardware. One solution may be to have a combination of various compute options/types that provide good cost to performance ratio for normal tasks, while also being able to handle extreme performance for specific tasks. In such a scenario, load balancer 150 is required to select the most appropriate compute option for each incoming request.

However, load balancers are typically designed to route each incoming request to a compute node that is deemed to be “less utilized” (as determined by various well-known techniques). Load balancers generally do not consider the “nature” (computational power required for processing) of the incoming requests when selecting the compute nodes/types. As noted in the Background section, incoming requests are typically diverse in that they may greatly differ in the computational power required for processing them. In addition, traditional load balancing techniques, such as round-robin or least-connections, often lack the ability to learn from past performance or adapt to real-time changes.

Load balancer 150, extended according to several aspects of the present disclosure, facilitates routing diverse incoming requests to optimal computing options while satisfying requisite performance metrics as described below with examples.

### 4. Routing Diverse Incoming Requests to Optimal Computing Options

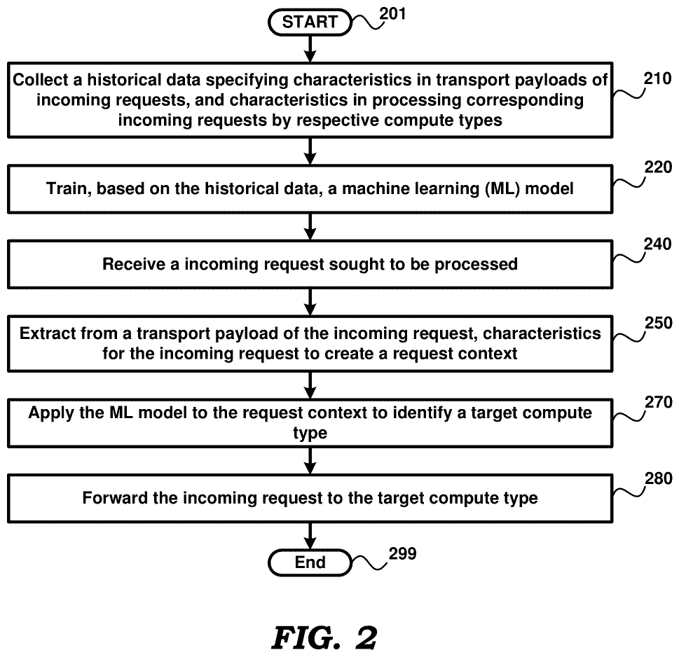

FIG. 2 is a flow chart illustrating the manner in which routing diverse incoming requests to optimal computing options while satisfying requisite performance metrics is facilitated according to aspects of the present disclosure. The flowchart is described with respect to the systems of FIGS. 1A and 1B, in particular load balancer 150, merely for illustration. However, many of the features can be implemented in other environments also without departing from the scope and spirit of several aspects of the present invention, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present invention. The flow chart begins in step 201, in which control immediately passes to step 210.

In step 210, a historical data containing characteristics in transport payloads of incoming requests (hereinafter “request characteristics”), and characteristics in processing corresponding incoming requests by respective compute types (hereinafter “processing characteristics”) is collected. While request characteristics may be collected by load balancer 150, the processing characteristics may be collected by performance analyzer 190.

According to an aspect, the request characteristics of an incoming request includes a resource path identifying a specific resource sought to be accessed, a verb indicating an action the incoming request seeks to perform on the specific resource, one or more query parameters specifying additional information for performing the action, and a payload size indicating the size of the transport payload of the incoming request.

According to another aspect, the processing characteristics includes data indicating a respective compute type identified for the incoming request, and whether the processing of the incoming request by the respective compute type was a success or failure in meeting requisite performance metrics (such as response time, cost of processing, throughput, and resource utilization in the respective compute type).

In step 220, load balancer 150 trains, based on the historical data, a machine learning (ML) model. Training the ML model may entail extracting one or more features from the request/processing characteristics and providing the features as inputs to an ML approach. In one embodiment described below, the ML model is a reinforcement learning (RL) model generated by a Thompson Sampling (RL) technique/approach. Such a trained ML model may thereafter be used to select compute types for incoming requests, as will be readily apparent to one skilled in the relevant arts. It may be noted that such a trained RL model will evolve itself based on the environmental changes (compute infrastructure, request context, SLA changes) and is well known as a self-learning model.

In step 240, load balancer 150 receives an incoming request sought to be processed. The incoming request may be received via path 151 from a requesting system such as an end-user system 110, compute node in other clouds (similar to 170) or one of nodes 135/145/165.

In step 250, load balancer 150 extracts from a transport payload of the incoming request, characteristics for the incoming request to create a request context. The extraction may entail inspecting the binary/text data of the transport payload to identify the specific text/value corresponding to the different request characteristics.

The request context is a structured representation of the request characteristics that may be used for subsequent steps like load balancing, authentication, or request routing. In one embodiment describe below, a request context is a single, structured object that encapsulates all relevant aspects of the request. In alternative embodiments, additional processing may be performed to generate a single value/structure that represents the specific combination of the extracted request characteristics. It may be noted that the request context captures the “nature” of the incoming request.

In step 270, load balancer 150 applies the ML model to the request context to identify a target compute type. Applying the ML model typically entails providing the request context as an input to the ML model and receiving the target compute type as the output of the ML model.

According to an aspect, the RL model noted above maintains beta distributions corresponding to combinations of request contexts and compute types used for processing the request contexts. Accordingly, load balancer 150 first determines, based on the RL model, a set of beta distributions corresponding to the new request context. Load balancer 150 then samples each of the set of beta distributions to estimate a corresponding success probability for each compute type and sets the target compute type to a compute type with a maximum value for the corresponding success probability.

In step 280, load balancer 150 forwards the incoming request to the target compute type. Specifically, load balancer 150 forwards the incoming request to a target compute node (one of the computer nodes 180) that is categorized as the target compute type. Control passes to step 299, where the flowchart ends.

Thus, load balancer 150 facilitates routing diverse incoming requests to optimal computing options (compute types) while satisfying requisite performance metrics. Load balancer 150 may thereafter receive a response to the incoming request from the target compute node/type and forwards the response to the requesting system. The description is continued with the manner in which incoming requests are received by load balancer 150 in one embodiment.

### 5. Incoming Request Format

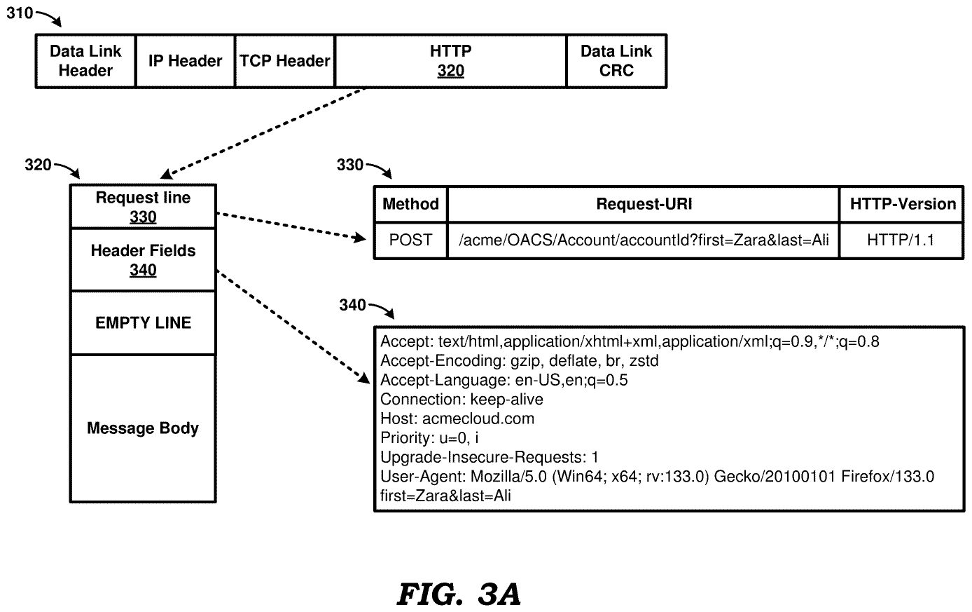

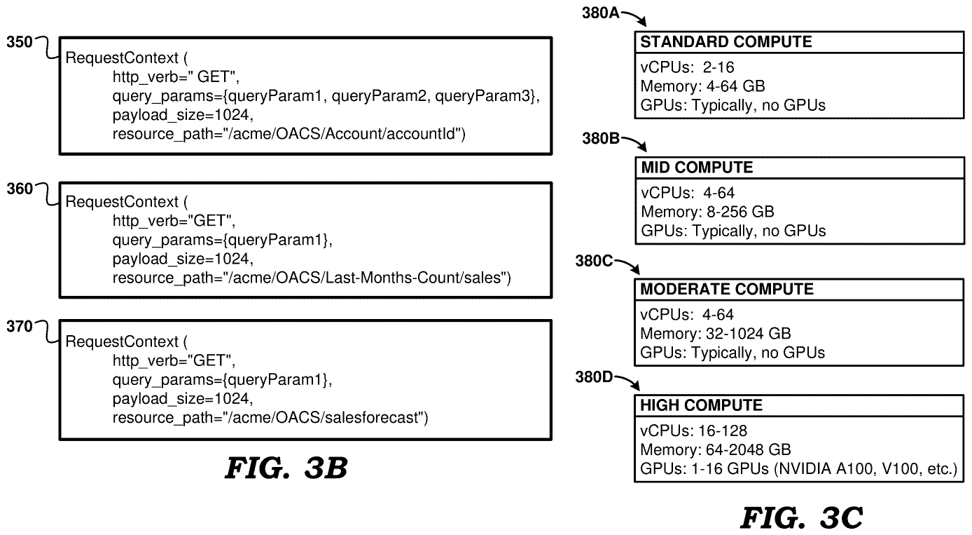

FIG. 3A depicts the format of a packet encoding an incoming request in one embodiment. For illustration, it is assumed that the incoming requests are HTTP (Hypertext Transfer Protocol) requests received according to the REST (Representational State Transfer) paradigm, and accordingly, the format of such an HTTP request packet is described below. However, in alternative embodiments, aspects of the present disclosure may be implemented for the incoming requests received according to other protocols, as will be apparent to one skilled in the relevant arts by reading the disclosure herein.

Data portion 310 depicts the format of an HTTP incoming request packet and is shown containing a data link header, an IP header, a TCP Header, HTTP portion 320 and a data link CRC (cyclic redundancy check). HTTP portion 320, in turn, is shown containing request line 330, header fields 340, empty line (carriage return+line feed characters) and a message body. In the disclosure herein, HTTP portion 320 represents the transport payload of the incoming request.

Request line 330 is shown containing a method, request-URI (Uniform Resource Identifier) and a HTTP-version. The method indicates whether request-URI is to be retrieved from the resource (e.g., when set to GET, etc.) or to be created/updated to the resource (e.g., when set to PUT, POST, DELETE, etc.). The request-URI identifies the resource on which the request is applied. In the disclosure herein, the term “resource” may refer to any software, hardware or data component that is allowed to be accessed by incoming requests. It may be observed that the request-URI includes query parameters (the key=value pairs after the “?”). The HTTP-version indicates the version of HTTP.

Header fields 340 contain multiple lines, with each line in the format of “field name: field value”, with the field names being typically specified by HTTP. It may be observed that the query parameters may be specified as part of header fields 340, as indicated by the last line there.

Upon receiving the HTTP incoming request, load balancer 150 extracts from the transport payload (data portion 320) of the incoming request, request characteristics to create a request context. Some sample request contexts that may be created for incoming requests is described detail below with examples.

### 6. Request Contexts

FIG. 3B depicts the request contexts created for different incoming requests in one embodiment. As noted above, a request context is a single, structured object that encapsulates all relevant aspects of the request. In one embodiment, the request characteristics that are used to create a request context are:
HTTP Verb (http verb): The HTTP verb (or method) indicates the action the incoming request intends to perform on the resource, such as GET, POST, PUT, DELETE;
Query Parameters (query params): Key-value pairs appended to the URI that provide additional information to the server, often used to filter or modify the data returned;
Payload Size (payload size): The size of the request body, measured in bytes, which includes data sent as part of the incoming request such as form submissions or JSON (JavaScript Object Notation) payloads; and
Resource Path (resource path): The part of the URI that identifies the specific resource or endpoint being accessed, providing context for routing and processing.

It may be appreciated that the request characteristics noted above may be extracted from transport payload 320 in the packet shown in FIG. 3A. For example, HTTP verb may be extracted from the method in request line 330, the query parameters from request-URI in request line 330 or from header fields 340, the payload size from the number of bytes in the message body, and the resource path from the request-URI in request line 330.

Data portions 350, 360 and 370 depict the request contexts created for different incoming requests. Specifically, data portion 350 depicts the request context created for an incoming (simple) request for getting the account details. Data portion 360 depicts the request context created for an incoming (normal) request for performing business analytics on sales data of the last few months. Data portion 370 depicts the request context created for an incoming (complex) request for performing machine learning analysis of the last few years' massive sales data to further forecast the sales for the next few months.

It may be appreciated that such request contexts provide consistency, modularity and efficiency in the handling of incoming requests. By standardizing how incoming requests are represented, all processing components (e.g., load balancer 150, performance analyzer 190, application services 185, etc.) in cloud 170 rely on a consistent structure, reducing the chance of errors. The request context allows for cleaner separation of concerns within the processing components. The request context encapsulates all necessary information, reducing overhead in repeatedly extracting and parsing data from the raw (HTTP) request.

Load balancer 150 uses the request contexts as the basis for identifying target compute types suitable for processing the corresponding incoming requests. The sample compute types available in the computing environment of cloud 170 is described below with examples.

### 7. Compute Types

FIG. 3C the compute type available in a computing environment (cloud 170) in one embodiment. Specifically, 380A-380D respectively depict the details of a standard compute, a mid compute, a moderate compute and a high compute available in cloud 170. Each of the compute types is described in detail below.

Standard compute (general-purpose) 380A has balanced CPU and memory, suitable for a wide range of general-purpose applications such as web servers, small to medium databases, and development environments. Example instances of standard compute 380A are AWS: t3, m5 (e.g., t3.medium, m5.large), Azure: Dsv3 series (e.g., Standard D2s v3), GCP: n1-standard and e2-standard (e.g., n1-standard-2) and OCI: VM.Standard.E3 and VM.Standard2 (e.g., VM.Standard.E3.Flex).

Mid compute (compute-optimized) 380B has higher CPU-to-memory ratio, designed for compute-intensive workloads such as batch processing, high-performance web servers, and scientific modeling. Example instances of mid compute 380B are AWS: c5, c6g (e.g., c5.large, c5.2xlarge), Azure: Fsv2 series (e.g., Standard F4s v2), GCP: n2-highcpu (e.g., n2-highcpu-4) and OCI: VM.Standard.E4.Flex, VM.Optimized3 (e.g., VM.Optimized3.Flex).

Moderate compute (memory-optimized) 380C has higher memory-to-CPU ratio, ideal for memory-intensive applications like in-memory databases, large data processing workloads, and high-performance databases. Example instances of moderate computer 380C are AWS: r5, x1e (e.g., r5.large, x1e.2xlarge), Azure: Esv3 series (e.g., Standard E16s v3), GCP: n1-highmem, m1-megamem (e.g., n1-highmem-4) and OCI: VM.Standard.E4.Flex and BM.Standard.E4 (e.g., BM.Standard.E4.128).

High compute (accelerated/High-Performance Computing—HPC) 380D has powerful compute with GPUs or specialized hardware for machine learning, AI (artificial intelligence), high-performance computing, and real-time data processing. Example instances of high compute 380D are AWS: p4, p3, g4dn (e.g., p3.2xlarge, p4d.24xlarge), Azure: NC and ND series for GPU (e.g., Standard NC6, Standard ND24s), GCP: a2-highgpu and n1-standard with GPU support (e.g., a2-highgpu-8g) and OCI: BM.GPU4.8 and BM.GPU3.8 (e.g., BM.GPU4.8 with NVIDIA A100 GPUs).

It may be appreciated that the cost of processing an incoming request in any compute type depends on many things, like compute power, network strength, secondary storage, etc. For illustration, it is assumed that the cost of processing (that is, compute cost) for the same incoming request is:
Standard Compute<Mid Compute<Moderate Compute<High Compute

One objective of the present disclosure is to route the incoming requests to the appropriate compute types to optimally make use of the provided infrastructure in cloud 170. The manner in which load balancer 150 (in association with performance analyzer 190) operates to ensure that optimal compute types are provided when routing diverse incoming requests is described below with examples.

### 8. Load Balancer

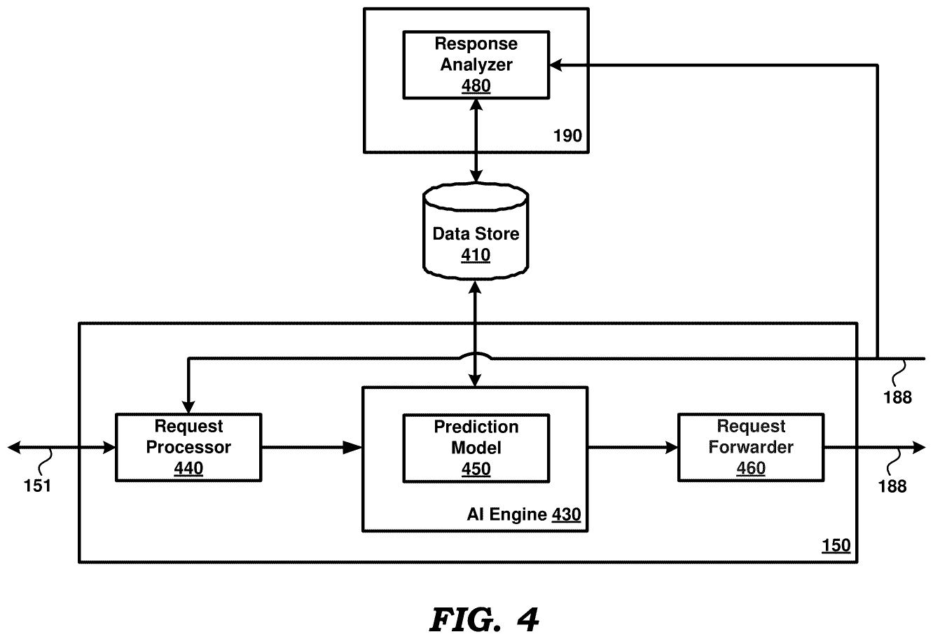

FIG. 4 is a block diagram depicting an implementation of a load balancer (150) in one embodiment. The block diagram is shown containing data store 140, AI (artificial intelligence) engine 430 (in turn, shown containing prediction model 450), request processor 440, request forwarder 460 and response analyzer 480 (shown internal to performance analyzer 190). Each of the blocks is described in detail below.

Data store 410 represents a data store that maintains portions of historical data containing request characteristics and processing characteristics. Data store 410 also stores the statistics of load balancer 150, performance history indicating the current and average values for performance metrics, requisite values for performance metrics, etc. In one embodiment, data store 410 is implemented using a cache and a database, with the data noted above being stored first in the cache for faster access. The stored data is periodically persisted in the database to ensure that the system retains learned insights and continues improving its routing decisions across multiple sessions.

AI engine 430 generates and maintains various machine learning models, such as prediction model 450. The models may be generated using any machine learning or deep learning approaches, either supervised or unsupervised. Examples of machine learning (ML) approaches/techniques are KNN (K Nearest Neighbor), Decision Tree, Reinforcement Learning (RL) etc., while deep learning (DL) approaches/techniques are Multilayer Perceptron (MLP), Convolutional Neural Networks (CNN), Long short-term memory networks (LSTM), Deep Reinforcement Learning (DRL) etc. Various other non-supervised or supervised ML/DL approaches/techniques can be employed, as will be apparent to skilled practitioners, by reading the disclosure provided herein.

The generation of a machine learning model typically entails training the model based on historical data maintained in data store 410. Training a model entails extracting one or more features from the historical data and providing the features as inputs to a selected ML approach. The selected ML approach, in turn, generates one or more internal states (e.g., weights, parameters, curves, etc.) of the model, with the internal states correlating the input features to desired outputs, as is well known in the relevant arts. The internal states may be maintained in memory and/or in data store 410. After training, the trained model is applied to inference data (new, unseen data), whereby the inference data is provided as an input to the model, and the model predicts outputs corresponding to the inference data. In addition, the model evolves itself by getting the reward/penalty for the action being selected against the response performance statistics and SLA defined.

Prediction model 450 represents a model generated by AI engine 430 that correlates the request characteristics (request contexts) to the processing characteristics. In one embodiment described below, prediction model 450 is a Reinforcement Learning (RL) model generated using Thompson Sampling approach. After training, prediction model 450 is operative to predict/select optimal compute types for new incoming requests/request contexts.

It may be appreciated that though a single prediction model (450) is shown used to predict optimal compute types for different request contexts, in alternative embodiments, multiple prediction models (not shown) may be generated and maintained, with each prediction model designed to predict compute types for a corresponding single request context. The manner in which new incoming requests are routed in described in detail below.

Request processor 440 receives (via path 151) incoming requests, extracts the request characteristics from each incoming request and creates corresponding request contexts. As noted above, load balancer 150 analyzes certain properties of the incoming request (such as HTTP Verb, Query Parameters, Payload Size, and Resource Path) to create a request context that encapsulates essential attributes of the incoming request, enabling load balancer 150 (and other downstream components) to identify the request requirements accurately. Request processor 440 forwards the created request contexts (along with the incoming requests) to prediction model 450.

Prediction model 450 predicts/selects a target compute type for the received request context. Broadly, prediction model 450 estimates the potential success of routing the incoming request to each available compute type. Using the estimated values, prediction model 450 selects the optimal compute type with the highest likelihood of meeting the QoS requirements (requisite performance metrics). Prediction model 450 then sends the selected target compute type (along with the incoming request) to request forwarder 460.

Request forwarder 460 receives the incoming requests and corresponding target computer types from prediction models 450A-450C, identifies target compute nodes from compute nodes 180 that are categorized as corresponding target compute types, and forwards (via path 188) the incoming requests to the target compute nodes. Though not shown, request forwarder 460 may maintain a mapping data that maps compute nodes to compute types to enable the identification noted above.

After processing of each incoming request is completed, request processor 440 receives (via path 188) a corresponding response from the target compute node and forwards the received response directly to the requesting system, completing the request-response cycle. The response is also processed for determining the processing performance (of the target compute node for the incoming request) as described below.

Response analyzer 480 determines current values for different performance metrics in the processing of an incoming request by a selected target compute type. The term “in the processing” may refer to obtaining the current values either during the processing of the incoming request or after the processing of the incoming request is completed (and a response is received). Each performance metric is associated with a respective requisite value stored in data store 410.

The current values may be obtained in a known way. For example, to obtain a response time/latency, request processor 440 may forward to response analyzer 480, a time instance (t1) at which an incoming request was received. Upon receiving the corresponding response at a second time instance (t2), response analyzer 480 may obtain the current value of latency as (t2−t1).

Response analyzer 480, for each performance metric, compares the current value with the requisite value to determine a status of whether the processing of the incoming request by the target compute type was a success (current value<requisite value) or failure (current value>requisite value) in terms of meeting requisite performance metrics. The response analyzer 480 adds the determined status to the historical data (in data store 410) as part of processing characteristics, thereby ensuring that the updated historical data is used thereafter to train prediction model 450; hence, this adds a self-learning capability of the model.

Thus, load balancer 150 (in association with performance analyzer 190) facilitates the routing of diverse incoming requests to optimal computing options while satisfying requisite performance metrics. The manner in which several aspects of the present disclosure are provided by the components of FIG. 4 is described below with examples.

### 9. Example Operation

As noted above, prediction model 450 is a Reinforcement Learning (RL) model generated using the Thompson Sampling approach. Accordingly, prediction model 450 maintains beta distributions corresponding to combinations of request contexts and compute types used for processing the request contexts. As is well known, a beta distribution is a continuous probability distribution defined on the interval [0, 1] with two shape parameters, α (alpha) and β (beta).

According to an aspect, for each beta distribution maintained (by prediction model 450) for a combination of a request context and a compute type, the alpha parameter indicates a success count of (previously) using the compute type for processing the request context, and the beta parameter indicates a failure count of using the compute type for processing the request context. The success count and failure count reflect the status (of whether the processing of the request context by the compute type was a success or failure) determined by response analyzer 480. The values of the alpha parameters and beta parameters for different beta distributions are maintained in data store 410.

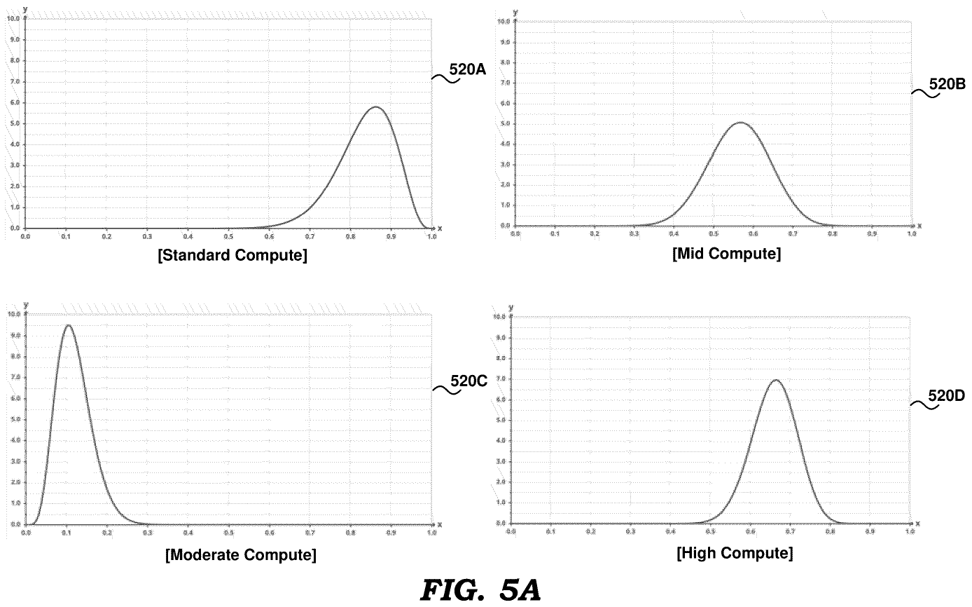

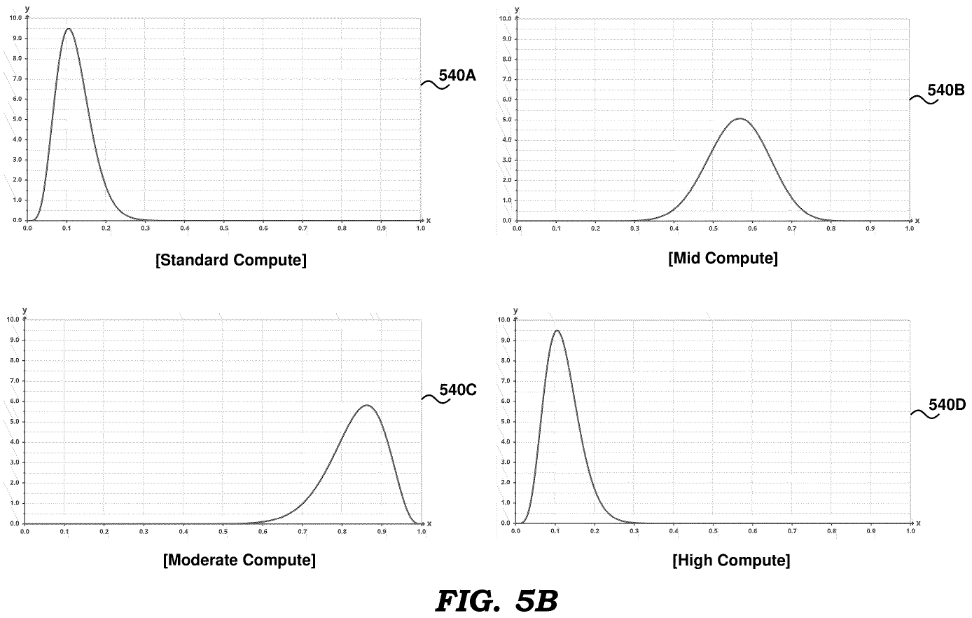

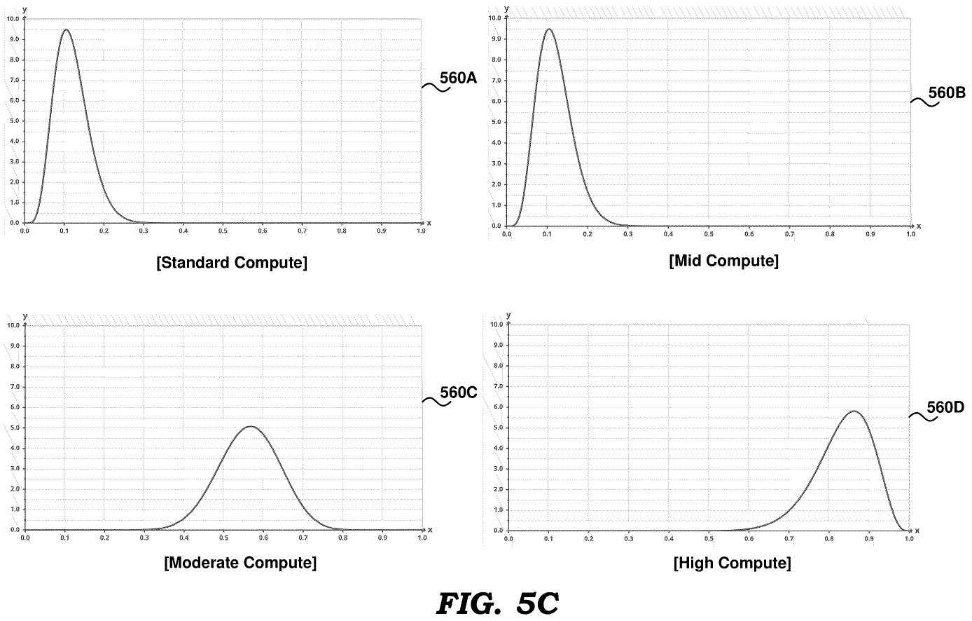

FIGS. 5A-5C depicts the beta distributions maintained for different request contexts in one embodiment. For convenience, each beta distribution is shown in the form of a graph plotted based on the values of the alpha and beta parameters. The x-axis of the graph represents a success probability (values from 0 to 1) of using the compute type for processing the request context, while the y-axis represents a number of samples (incoming requests). The graphs change dynamically as more incoming requests are processed by corresponding compute types with success or failure in meeting the requisite performance metrics.

Specifically, FIG. 5A depicts the beta distributions (generated) and maintained corresponding to the request context (data portion 350) for simple requests. 520A-520D respectively represent the beta distributions for a combinations of compute types (standard, mid, moderate, and high) and the “simple” request context. Similarly, FIG. 5B depicts the beta distributions (540A-540D) maintained corresponding to the request context (data portion 360) for normal requests, while FIG. 5C depicts the beta distributions (560A-560D) maintained corresponding to the request context (data portion 370) for complex requests.

Referring again to FIG. 4, upon receiving a request context from request processor 440, prediction model 450 identifies a set of beta distributions corresponding to the request context. Prediction model 450 then samples each of the set of beta distributions to estimate a corresponding success probability for each compute type and sets the target compute type to a compute type with a maximum value for the corresponding success probability.

For example, for the beta distributions shown in FIG. 5A, if the “simple” request context noted above is received, prediction model 450 first identifies the beta distributions 520A-520D corresponding to the “simple” request context, samples the beta distributions to obtain the success probabilities of {Standard compute=0.85, Mid compute=0.56, Moderate compute=0.10, High compute=0.65} and then sets the target compute type to the standard compute as the standard compute has the maximum success probability (0.85) in comparison to the other compute types. Similarly, prediction model 450 sets the target compute type to the moderate compute having maximum success probability (0.85) for “normal” request contexts, and to the high compute having maximum success probability (0.85) for “complex” request contexts. Prediction tool 450 then forwards the (selected) target compute type to request forwarder 460.

According to an aspect, response analyzer 480 also updates(self-learn) the RL model by modifying the alpha and beta parameters (maintained in data store 410) of the beta distributions based on the processing of incoming requests by target compute types. Specifically, after determining a current value of a performance metric in the processing of an incoming request by a selected target compute type, response analyzer 480 changes the alpha parameter using (by executing) a reward function and the beta parameter using a penalty function, where the reward function increases the alpha parameter when a current value is lower than the requisite value and the penalty function increases the beta parameter when the current value is higher than the requisite value.

For example, response analyzer 480 may determine that a current value for latency is 10 s (seconds) in the processing of a simple request, where the requisite value for latency is 15 s. Response analyzer 480 accordingly increases (e.g. by 1) the alpha parameter of the beta distribution shown in 520A (for combination of “simple” request context and standard compute) since the current value (10 s) is lower than the requisite value (15 s). The increase of the alpha parameter indicates that the standard compute is more suitable/optimal for processing “simple” request contexts as compared to other compute types.

Similarly, response analyzer 480 may determine that a current value for latency is 35 s (seconds) in the processing of a normal request, where the requisite value for latency is 25 s. Response analyzer 480 accordingly increases (e.g. by 1) the beta parameter of the beta distribution shown in 540C (for the combination of “normal” request context and moderate compute) since the current value (35 s) is higher than the requisite value (25 s). The increase of the beta parameter indicates that the moderate compute is not suitable/optimal for processing “normal” request contexts as compared to other compute types.

By continuously updating the Thompson Sampling RL model (450), load balancer 150 becomes more effective at meeting requisite performance metrics (e.g., minimizing latency) and minimizing compute costs, adapting to the evolving nature of the workload (incoming requests). Such updating enables load balancer 150 to refine its understanding of the suitability of each compute type (by extension, compute nodes) over time. Such an approach allows for intelligent throttling and optimal resource utilization, ultimately delivering a more responsive and cost-efficient cloud (170).

According to an aspect, response analyzer 480 also performs cost optimization in the selection of compute types for different request contexts. As part of the optimization, response analyzer 480 updates the RL model by modifying the alpha and beta parameters in addition to the modification based on the performance metrics as described above. The manner in which such cost optimization is performed is described below with examples.

### 10. Optimizing Cost in the Selection of Compute Types & Self-Learning

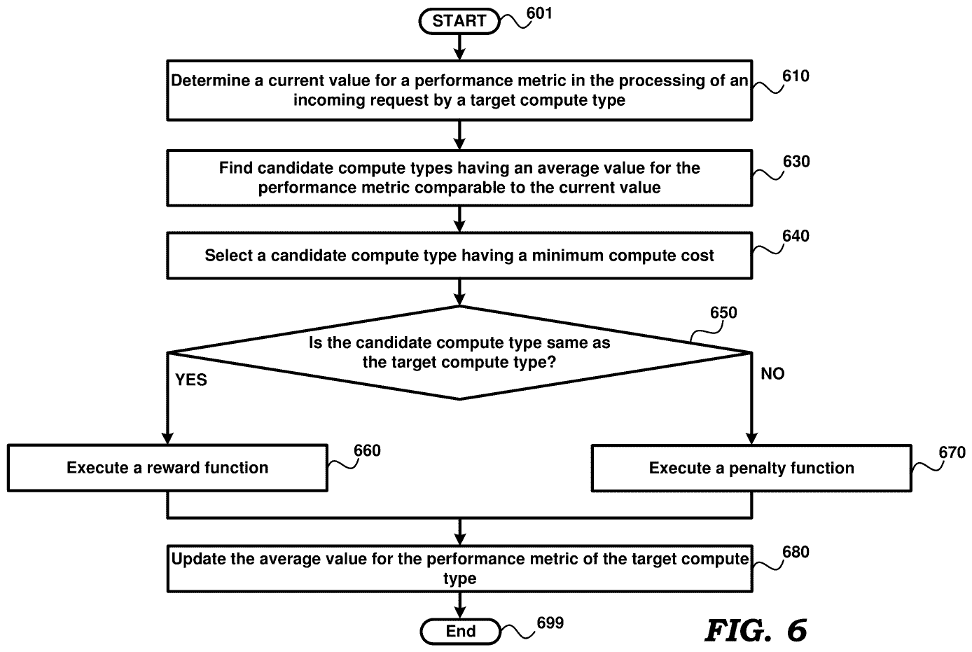

FIG. 6 is a flow chart illustrating the manner in which the cost optimization in the selection of compute types for incoming requests is performed according to aspects of the present disclosure. The flowchart is described with respect to the systems of FIG. 4, in particular response analyzer 480, merely for illustration. However, many of the features can be implemented in other environments also without departing from the scope and spirit of several aspects of the present invention, as will be apparent to one skilled in the relevant arts by reading the disclosure provided herein.

In addition, some of the steps may be performed in a different sequence than that depicted below, as suited to the specific environment, as will be apparent to one skilled in the relevant arts. Many of such implementations are contemplated to be covered by several aspects of the present invention. The flow chart begins in step 601, in which control immediately passes to step 610.

In step 610, response analyzer 480 determines a current value for a performance metric in the processing of an incoming request (having a corresponding request context) by a target compute type. The current value may be determined in any convenient manner. For example, the current value for latency may be determined based on time instances of receipt of the incoming request and the corresponding response, as described above with respect to FIG. 4. The description is continued assuming that the current value for latency is 35 s when an incoming request having a “normal” request context is processed by a moderate compute.

In step 630, response analyzer 480 finds (a set of) candidate compute types having an average value for the performance metric (in the processing of the corresponding request context) comparable to the current value. The term “comparable to” implies that the difference between the current value (c) and the average value (a) is within a pre-defined marginal value/margin of threshold (m). In other words, each candidate compute type satisfies the equation |c−a|<=m. The average value for the performance metric for different compute types in the processing of the corresponding request context may be retrieved from data store 410.

Assuming that the value of m=5 s, response analyzer 480 may retrieve the average values for latency for different compute types as Standard=45 s, Mid=30 s, Moderate=35 s and High=30 s. Response analyzer 480 according finds the set of candidate compute type to be {Mid, Moderate, High} as all of them have |c−a|<=5 s. It should be noted that the set of candidate compute types may include the target compute type. A set containing more than one compute type may indicate that there are other compute types providing performance similar to that of the target compute type.

In step 640, response analyzer 480 selects a candidate compute type (from the set) having a minimum compute cost (in the processing of the corresponding request context). As noted above, compute types are associated with different compute costs of processing incoming requests, and the selection of the minimum deems the selected candidate compute type to be most optimal (in terms of cost) compute type of the corresponding request context.

In the above example, response analyzer 480 selects Mid compute type from the set of {Mid, Moderate, High} in view of the Mid compute type having the minimum compute cost. It should be noted that the selection of the minimum cost also ensures that compute types having comparable performance but associated with higher cost (such as High compute type in the example) are not selected.

In step 650, response analyzer 480 checks whether the candidate compute type is the same as the target compute type. In other words, response analyzer 480 checks whether there exists another compute type that has got similar/equivalent performance while being associated with a smaller compute cost. Control passes to step 660, if they are the same (that is there is no other compute type giving the equivalent performance), and to step 670 otherwise.

In step 660, when the target compute type has the best performance for the corresponding request context, response analyzer 480 executes a reward function to indicate that the target compute type is the cost optimal selection for the corresponding request context. As noted above, the reward function increases (e.g. by 1) the alpha parameter of the beta distribution corresponding to the combination of the corresponding request context and the target compute type. Control passes to step 680.

In step 670, when the candidate compute type has the best performance for the corresponding request context, response analyzer 480 executes a penalty function to indicate that the target compute type is not the cost optimal selection for the corresponding request context. As noted above, the penalty function increases (e.g. by 1) the beta parameter of the beta distribution corresponding to the combination of the corresponding request context and the target compute type. Control passes to step 680.

In the above example, since the candidate compute type (Mid) is not equal to the target compute type (Moderate), control passes from step 650 to 670, where response analyzer 480 executes the penalty function to increase (e.g. by 1) the beta parameter of the beta distribution shown in 540C (for combination of “normal” request context and moderate compute). The increase of the beta parameter indicates that the moderate compute is not optimal (in terms of cost as well) for processing “normal” request contexts as compared to other compute types.

In step 680, response analyzer 480 updates the average value for the performance metric of the target compute type. A new average value is calculated based on the previous average value (retrieved in step 630), the current value and the total number of incoming requests processed by the target compute type. The updated average value may be stored in data store 180, for later retrieval. Control passes to step 699, where the flow chart ends.

Thus, decision-making process leverages Thompson Sampling, a probabilistic approach that helps the load balancer (150) dynamically balance between exploring new compute allocations and exploiting known optimal configurations. Such an approach continuously updates the model based on observed QoS outcomes (e.g., latency and compute cost), thereby improving and adapting routing decisions over time.

The instant disclosure offers several benefits such as 1) Adaptive Decision-Making: The load balancer learns from the environment, improving routing decisions over time; 2) Cost Efficiency: By prioritizing less expensive resources/compute types, the system reduces operational costs; 3) Scalability: The RL-based load balancer can scale with increasing traffic and adapt to changes in resource availability; and 4) Performance Optimization: Routing requests to the most suitable resources reduces latency and improves user experience.

It may be appreciated that aspects of the present disclosure route incoming requests to the appropriate compute infrastructure to optimally make use of the provided infrastructure. In addition, the cloud vendor may statistically calculate the percentage of high/low compute type infrastructure required based upon the number of incoming requests classified as requiring high/low compute as stored in the data store (410). Thus, just running a basic analysis on the data store, the cloud vendor can decide the percentage of costly high compute infrastructure they require to optimally service the client requests.

Furthermore, as the services and features provided by a SaaS (hosted in cloud 170) are developed and extended, the data store will provide a dynamic reference for the cloud vendor for calculating the infrastructure requirements. Thus, if a stock trading service adds a historical analysis tool, the cloud vendor will dynamically know if the high compute requirements are increased due to the number of incoming requests for the historical analysis.

It may also be appreciated that the margin of threshold value (m, noted above) used herein is a dynamic knob which can be used by a SaaS provider to easily shift the boundary between standard and high compute requirements. Thus, if the standard compute infrastructure is upgraded, just reducing the value of the margin of threshold would mean that the standard compute infrastructure would start handling more compute intensive tasks and the percentage of high compute infrastructure required would decrease.

In addition, aspects of the present disclosure enable a load balancer to be self-learnable, which could be able to throttle the incoming requests based on the historical classification of an incoming request so as not to route to a compute type if there is a resource crunch or some scaling is in progress.

It should be further appreciated that the features described above can be implemented in various embodiments as a desired combination of one or more of hardware, software, and firmware. The description is continued with respect to an embodiment in which various features are operative when the software instructions described above are executed.

### 11. Digital Processing System

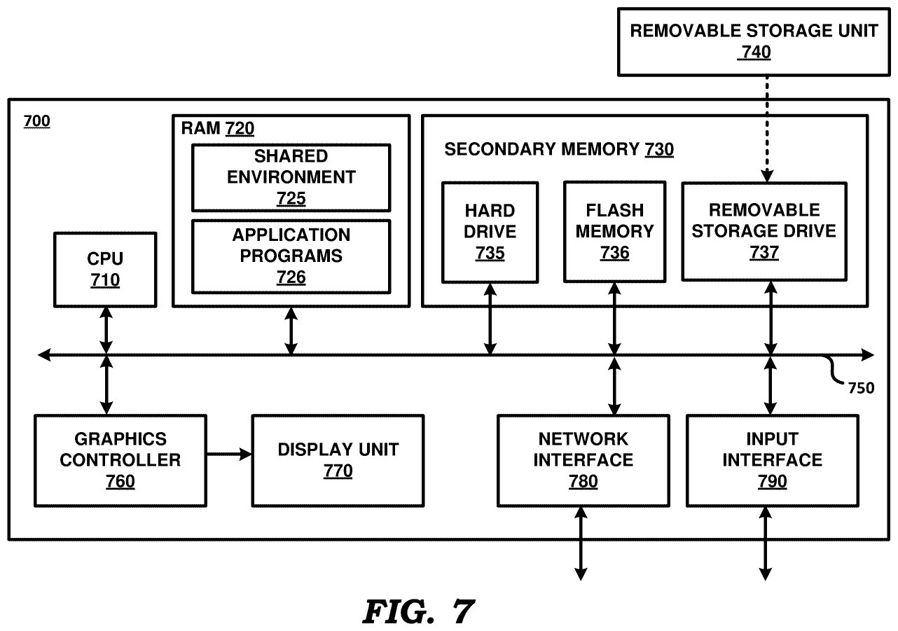

FIG. 7 is a block diagram illustrating the details of digital processing system (700) in which various aspects of the present disclosure are operative by execution of appropriate executable modules. Digital processing system 700 may correspond to load balancer 150 or performance analyzer 190.

Digital processing system 700 may contain one or more processors such as a central processing unit (CPU) 710, random access memory (RAM) 720, secondary memory 730, graphics controller 760, display unit 770, network interface 780, and input interface 790. All the components except display unit 770 may communicate with each other over communication path 750, which may contain several buses as is well known in the relevant arts. The components of FIG. 7 are described below in further detail.

CPU 710 may execute instructions stored in RAM 720 to provide several features of the present disclosure. CPU 710 may contain multiple processing units, with each processing unit potentially being designed for a specific task. Alternatively, CPU 710 may contain only a single general-purpose processing unit.

RAM 720 may receive instructions from secondary memory 730 using communication path 750. RAM 720 is shown currently containing software instructions constituting shared environment 725 and/or other user programs 726 (such as other applications, DBMS, etc.). In addition to shared environment 725, RAM 720 may contain other software programs such as device drivers, virtual machines, etc., which provide a (common) run time environment for execution of other/user programs.

Graphics controller 760 generates display signals (e.g., in RGB format) to display unit 770 based on data/instructions received from CPU 710. Display unit 770 contains a display screen to display the images defined by the display signals. Input interface 790 may correspond to a keyboard and a pointing device (e.g., touch-pad, mouse) and may be used to provide inputs. Network interface 780 provides connectivity to a network (e.g., using Internet Protocol), and may be used to communicate with other systems connected to the network.

Secondary memory 730 may contain hard drive 735, flash memory 736, and removable storage drive 737. Secondary memory 730 may store the data (e.g., data shown in FIGS. 3A-3C and 5A-5C) and software instructions (e.g., for performing the actions of FIGS. 2 and 6, for implementing the blocks of FIG. 4), which enable digital processing system 700 to provide several features in accordance with the present disclosure. The code/instructions stored in secondary memory 730 may either be copied to RAM 720 prior to execution by CPU 710 for higher execution speeds, or may be directly executed by CPU 710.

Some or all of the data and instructions may be provided on removable storage unit 740, and the data and instructions may be read and provided by removable storage drive 737 to CPU 710. Removable storage unit 740 may be implemented using medium and storage format compatible with removable storage drive 737 such that removable storage drive 737 can read the data and instructions. Thus, removable storage unit 740 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 740 or hard disk installed in hard drive 735. These computer program products are means for providing software to digital processing system 700. CPU 710 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 730. Volatile media includes dynamic memory, such as RAM 720. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 750. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

It should be understood that the figures and/or screen shots illustrated in the attachments highlighting the functionality and advantages of the present disclosure are presented for example purposes only. The present disclosure is sufficiently flexible and configurable, such that it may be utilized in ways other than that shown in the accompanying figures.

### 12. Conclusion

While various embodiments of the present disclosure have been described above, it should be understood that they have been presented by way of example only, and not limitation. Thus, the breadth and scope of the present disclosure should not be limited by any of the above-described exemplary embodiments, but should be defined only in accordance with the following claims and their equivalents.

It should be understood that the figures and/or screen shots illustrated in the attachments highlighting the functionality and advantages of the present disclosure are presented for example purposes only. The present disclosure is sufficiently flexible and configurable, such that it may be utilized in ways other than that shown in the accompanying figures.

Further, the purpose of the following Abstract is to enable the Patent Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present disclosure in any way.

What is claimed is:

1. A method of routing incoming requests in a computing environment comprising a plurality of compute types, said method comprising:
collecting a historical data comprising:
a first set of characteristics in transport payloads of incoming requests, and
a second set of characteristics in processing corresponding incoming requests by respective compute types;
training, based on said historical data, a machine learning (ML) model to select compute types for incoming requests;
receiving a new incoming request sought to be processed;
extracting from a transport payload of said new incoming request, said first set of characteristics to create a new request context;
applying said ML model to said new request context to identify a target compute type of said plurality of compute types; and
forwarding said new incoming request to said target compute type.

2. The method of claim 1, wherein said first set of characteristics in transport payload of an incoming request includes a resource path identifying a specific resource sought to be accessed, a verb indicating an action said incoming request seeks to perform on said specific resource, one or more query parameters specifying additional information for performing said action, and a payload size indicating the size of said transport payload of said incoming request.

3. The method of claim 2, wherein said second set of characteristics includes data indicating a respective compute type identified for said incoming request, and whether the processing of said incoming request by said respective compute type was a success or failure in meeting requisite performance metrics,
wherein said requisite performance metrics includes one or more of response time, cost of processing, throughput, and resource utilization in said respective compute type.

4. The method of claim 1, wherein said ML model is a reinforcement learning (RL) model that maintains beta distributions corresponding to combinations of request contexts and compute types used for processing said request contexts,
wherein said applying comprises:
identifying, based on said RL model, a set of beta distributions corresponding to said new request context;
sampling each of said set of beta distributions to estimate a corresponding success probability for each compute type; and
setting said target compute type to a compute type with a maximum value for said corresponding success probability.

5. The method of claim 4, wherein a beta distribution for the combination of said new request context and said target compute type is defined by an alpha parameter and a beta parameter, wherein said alpha parameter indicates a success count of using said target compute type for processing said new request context, and said beta parameter indicates a failure count of using said target compute type for processing said new request context,
said method further comprising:
determining a current value for a performance metric in the processing of said new incoming request by said target compute type, said performance metric being associated with a requisite value; and
changing said alpha parameter using a reward function and said beta parameter using a penalty function, wherein said reward function increases said alpha parameter when said current value is lower than said requisite value and said penalty function increases said beta parameter when said current value is higher than said requisite value.

6. The method of claim 5, wherein each of said plurality of compute types is associated with a corresponding compute cost, wherein said changing comprises:
finding a set of candidate compute types having an average value for said performance metric comparable to said current value;
selecting from said set of candidate compute types, a candidate compute type having a minimum compute cost; and
executing said reward function if said candidate compute type is same as said target compute type and said penalty function otherwise.

7. The method of claim 7, wherein said plurality of compute types comprises standard compute, mid compute, moderate compute and high compute, wherein said RL model is generated using Thompson Sampling technique.

8. A non-transitory machine-readable medium storing one or more sequences of instructions for routing incoming requests in a computing environment comprising a plurality of compute types, wherein execution of said one or more instructions by one or more processors contained in a digital processing system causes said digital processing system to perform the actions of:
receiving a new incoming request sought to be processed;
extracting from a transport payload of said new incoming request, said first set of characteristics to create a new request context;
applying a ML model to said new request context to identify a target compute type of said plurality of compute types, wherein said ML model is formed prior to receipt of said new incoming request by training, based on a historical data, said machine learning (ML) model to select compute types for incoming requests,
said historical data comprising a first set of characteristics in transport payloads of incoming requests, and a second set of characteristics in processing corresponding incoming requests by respective compute types; and
forwarding said new incoming request to said target compute type.

9. The non-transitory machine-readable medium of claim 8, wherein said first set of characteristics in transport payload of an incoming request includes a resource path identifying a specific resource sought to be accessed, a verb indicating an action said incoming request seeks to perform on said specific resource, one or more query parameters specifying additional information for performing said action, and a payload size indicating the size of said transport payload of said incoming request.

10. The non-transitory machine-readable medium of claim 9, wherein said second set of characteristics includes data indicating a respective compute type identified for said incoming request, and whether the processing of said incoming request by said respective compute type was a success or failure in meeting requisite performance metrics,
wherein said requisite performance metrics includes one or more of response time, cost of processing, throughput, and resource utilization in said respective compute type.

11. The non-transitory machine-readable medium of claim 8, wherein said ML model is a reinforcement learning (RL) model that maintains beta distributions corresponding to combinations of request contexts and compute types used for processing said request contexts,
wherein said applying comprises one or more instructions for:
identifying, based on said RL model, a set of beta distributions corresponding to said new request context;
sampling each of said set of beta distributions to estimate a corresponding success probability for each compute type; and
setting said target compute type to a compute type with a maximum value for said corresponding success probability.

12. The non-transitory machine-readable medium of claim 11, wherein a beta distribution for the combination of said new request context and said target compute type is defined by an alpha parameter and a beta parameter, wherein said alpha parameter indicates a success count of using said target compute type for processing said new request context, and said beta parameter indicates a failure count of using said target compute type for processing said new request context,
further comprising one or more instructions for:
determining a current value for a performance metric in the processing of said new incoming request by said target compute type, said performance metric being associated with a requisite value; and
changing said alpha parameter using a reward function and said beta parameter using a penalty function, wherein said reward function increases said alpha parameter when said current value is lower than said requisite value and said penalty function increases said beta parameter when said current value is higher than said requisite value.

13. The non-transitory machine-readable medium of claim 12, wherein each of said plurality of compute types is associated with a corresponding compute cost, wherein said changing comprises one or more instructions for:
finding a set of candidate compute types having an average value for said performance metric comparable to said current value;
selecting from said set of candidate compute types, a candidate compute type having a minimum compute cost; and
executing said reward function if said candidate compute type is same as said target compute type and said penalty function otherwise.

14. The non-transitory machine-readable medium of claim 13, wherein said plurality of compute types comprises standard compute, mid compute, moderate compute and high compute, wherein said RL model is generated using Thompson Sampling technique.

15. A computing environment comprising:
a plurality of compute nodes categorized into a plurality of compute types; and
a load balancer performing the actions of:
training, based on a historical data, a machine learning (ML) model to select compute types for incoming requests, wherein said historical data comprises:
a first set of characteristics in transport payloads of incoming requests, and
a second set of characteristics in processing corresponding incoming requests by respective compute types;
receiving a new incoming request sought to be processed;
extracting from a transport payload of said new incoming request, said first set of characteristics to create a new request context;
applying said ML model to said new request context to identify a target compute type of said plurality of compute types; and
forwarding said new incoming request to a target compute node of said plurality of compute nodes categorized as said target compute type.

16. The computing environment of claim 15, wherein said first set of characteristics in transport payload of an incoming request includes a resource path identifying a specific resource sought to be accessed, a verb indicating an action said incoming request seeks to perform on said specific resource, one or more query parameters specifying additional information for performing said action, and a payload size indicating the size of said transport payload of said incoming request.

17. The computing environment of claim 16, wherein said second set of characteristics includes data indicating a respective compute type identified for said incoming request, and whether the processing of said incoming request by said respective compute type was a success or failure in meeting requisite performance metrics,
wherein said requisite performance metrics includes one or more of response time, cost of processing, throughput, and resource utilization in said respective compute type.

18. The computing environment of claim 15, wherein said ML model is a reinforcement learning (RL) model that maintains beta distributions corresponding to combinations of request contexts and compute types used for processing said request contexts,
wherein for said applying, said load balancer performs the actions of:
identifying, based on said RL model, a set of beta distributions corresponding to said new request context;
sampling each of said set of beta distributions to estimate a corresponding success probability for each compute type; and
setting said target compute type to a compute type with a maximum value for said corresponding success probability.

19. The computing environment of claim 18, wherein a beta distribution for the combination of said new request context and said target compute type is defined by an alpha parameter and a beta parameter, wherein said alpha parameter indicates a success count of using said target compute type for processing said new request context, and said beta parameter indicates a failure count of using said target compute type for processing said new request context,
further comprising a performance analyzer performing the actions of:
determining a current value for a performance metric in the processing of said new incoming request by said target compute type, said performance metric being associated with a requisite value; and
changing said alpha parameter using a reward function and said beta parameter using a penalty function, wherein said reward function increases said alpha parameter when said current value is lower than said requisite value and said penalty function increases said beta parameter when said current value is higher than said requisite value.

20. The computing environment of claim 19, wherein each of said plurality of compute types is associated with a corresponding compute cost, wherein for said changing, said performance analyzer performs the actions of:
finding a set of candidate compute types having an average value for said performance metric comparable to said current value;
selecting from said set of candidate compute types, a candidate compute type having a minimum compute cost; and
executing said reward function if said candidate compute type is same as said target compute type and said penalty function otherwise.
